(19) United States
(12) Patent Application Publication
(10) Pub. No.: US 2022/0317184 A1
(43) Pub. Date: Oct. 6, 2022

(54) SECURED DEBUG

(71) Applicants: STMicroelectronics (Alps) SAS, Grenoble (FR); STMicroelectronics (Grand Ouest) SAS, Le Mans (FR)

(72) Inventors: Franck Albesa, Parigne l'eveque (FR); Nicolas Anquet, Grenoble (FR)

(21) Appl. No.: 17/709,053

(22) Filed: Mar. 30, 2022

(30) Foreign Application Priority Data
Mar. 31, 2021 (FR) 2103315

(51) Int. Cl. G01R 31/317; G06F 21/60; G06F 21/75

(52) U.S. Cl. CPC G01R 31/31719; G01R 31/31705; G06F 21/602; G06F 21/75

(57) ABSTRACT

In an embodiment a method for debugging a processing device includes generating, by a monotonic counter of the processing device, a first count value, transmitting, by the monotonic counter, the first count value to a debug access control circuit, comparing, by the debug access control circuit of the processing device, the first count value with one or more reference values and authorizing or preventing debug access, by the debug access control circuit, based on the comparison.

### CROSS-REFERENCE TO RELATED APPLICATIONS

This application claims the benefit of French Patent Application No. 2103315, filed on Mar. 31, 2021, which application is hereby incorporated herein by reference.

### TECHNICAL FIELD

The present disclosure relates to methods and devices for securing electronic circuits, and in particular to a device and method for performing secure debugging of such a circuit.

### BACKGROUND

Debugging procedures for a processing device are likely to be problematic in applications where memories of the device contain confidential, sensitive data. This may include encryption keys, passwords, codes, or keys used in the life of the circuit, boot codes, or proprietary protocols stored in a device memory by the manufacturer of the device or by an intermediate entity between the manufacturer and an end user. It is desirable that the security of sensitive data should not be compromised during a debugging procedure.

### SUMMARY

Embodiments provide improvements to the security of access to sensitive data.

Various embodiments address all or some of the drawbacks of known processing devices.

Other embodiment provide a method for debugging a processing device, the method comprising generating, by a monotonic counter, a first count value, transmitting, by the monotonic counter, the first count value to a debug access control circuit, comparing, by the debug access control circuit, the first count with one or more reference values, and authorizing or preventing access for debugging by the debug access control circuit based on the comparison.

According to one embodiment, the first count value is generated in a first step of a boot sequence of the processing device, this first step comprising incrementing the monotonic counter to a second count value after transmission of the first count value.

According to one embodiment, the authorization or prevention comprises preventing access for debugging based on the first count value, the method further comprises transmitting, by the monotonic counter, the second count value to the debug access control circuit, comparing, by the debug access control circuit, the second count value with the said one or more reference values and authorizing debug access based on the second count value.

According to one embodiment, the first count value corresponds to an initialization value of the monotonic counter during a first boot of the processing device and the second count value corresponds to an initialization value of the monotonic counter at a second boot of the processing device.

According to one embodiment, during the first boot, the processing device is initially placed in a first state in which the debug access by the debug access circuit is authorized based on the first count value, and, during the second boot, the processing device is locked in a second state in which the debug access by the debug access circuitry is prevented based on the first count value.

According to one embodiment, the method further comprises transmitting the first count value, by the monotonic counter, to an access control circuit of a memory of the processing device, reading, based on the first count value, of the first data stored in the memory, transmitting the second count value, by the monotonic counter, to the access control circuit of the memory of the processing device and reading, based on the second count value, of the second data stored in the memory, the memory access control circuit being configured such that reading of the first data is not authorized based on the second count value.

According to one embodiment, the first and second states of the processing device are defined by one or more values stored in the memory.

According to one embodiment, the debug access control circuit authorizes debug access based on a count value greater than or equal to the said one or more reference values and prevents debug access based on a count value strictly less than the said one or more reference values.

According to one embodiment, the method further comprises, prior to authorizing or preventing debugging access, receiving by the debug access circuit a debug access request from an external device and verifying by the debug access circuit of authentication of the external device, wherein authorization or prevention of debug access by the debug access control circuit is also performed based on the authentication verification.

One embodiment provides a data processing device comprising a monotonic counter configured to generate a first count value and a debug access control circuit configured to compare the first count value with one or more reference values and authorize or prevent debug access based on the comparison.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 is a schematic representation in block form of an electronic device according to an embodiment;

FIG. 2 is a flowchart representing the operations of a method for operating the device in debugging mode according to an embodiment;

FIG. 3 illustrates an example of a life cycle of the processing device comprising a debugging procedure according to an embodiment;

FIG. 4 represents data and codes accessible during a secure boot according to an embodiment;

FIG. 5 is a flowchart of a secure boot method of a processing device according to an embodiment; and

FIG. 6 is a flowchart of a secure boot method of a processing device according to another embodiment.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional, and material properties.

For the sake of clarity, only the operations and elements that are useful for an understanding of the embodiments described herein have been illustrated and described in detail. In particular, the design of processing devices is well known to the person skilled in the art and certain elements have not been detailed in the following description.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures, or to a . . . as orientated during normal use.

Unless specified otherwise, the expressions “around”, “approximately”, “substantially” and “in the order of” signify within 10%, and preferably within 5%.

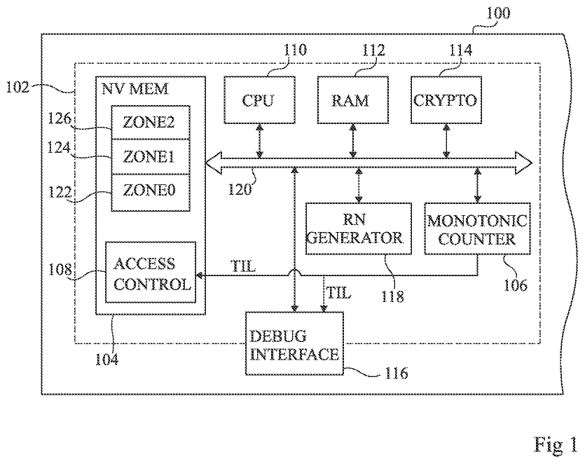

FIG. 1 depicts, very schematically and in block form, an electronic device 100 comprising a processing device 102 according to an embodiment.

The electronic device 100 is, for example, an electronic board such as a microcircuit board, hardware for computer use, a microprocessor circuit, etc.

The processing device 102 comprises, for example, a non-volatile memory 104 (NV MEM), such as a flash memory and a monotonic counter 106 (MONOTONIC COUNTER).

Monotonic counters are known in the art. An example of such a counter is described in the publication “Virtual Monotonic Counters and Count-Limited Objects using a TPM without a Trusted OS” by L. F. G. Sarmenta, M. Van Dijk, C. W. O'Donnell, J. Rhodes and S. Devadas, and in particular in part 3 of this paper. This paper is incorporated herein by references in its entirety and describes embodiments of counters implemented in hardware and/or software form. The monotonic counter 106 is for example implemented in hardware form by a digital circuit, such as an Application Specific Integrated Circuit (ASIC). The monotonic counter is configured to maintain a count value, accessible at an output of the counter. Following an increment instruction, the monotonic counter increases its count value by one or more units but, following each increment, the operation is not reversible. Indeed, the monotonic counter is configured so that its count value never decreases. Moreover, between two increments, the count value is protected against any modification, so that it cannot be erased nor changed. Only the increment instruction allows the current value to be replaced by a new value that is higher than the current value.

The monotonic counter 106 is configured so that no instruction, other than a reset to zero of the processing device, will allow the return to the previous value once the increment instruction is executed. In the case where the count value is stored in a volatile manner, each time the processing device is turned off, the count value is lost and each time the device is booted, the monotonic counter generates an initial count value again. In the case where the count value is stored in a non-volatile storage element, upon each reboot, an initial count value is, for example, written back to the non-volatile storage element of the monotonic counter.

The processing device 102 further comprises a generic processor no (CPU). For example, the generic processor no is coupled via a bus 120 to the monotonic counter 106 as well as to a RAM (random access memory) 112 and to the non-volatile memory 104. The memory 112 and/or the memory 104 store, for example, instructions for controlling the processor no. The generic processor no is further coupled via the bus 120 to a cryptographic processor 114 (CRYPTO) as well as a random number generator 118 (RN GENERATOR). The cryptographic processor 114 receives, via the bus 120, encrypted data and returns the decrypted data and/or receives, via the bus 120, unencrypted data and returns the encrypted data. In one example, the random number generator 118 is a pseudo random-number generator, such as a linear congruential generator, using recursive arithmetic sequences having a disordered behavior and having a period long enough to appear random. The quality of such a generator depends entirely on the arithmetic parameters used. In another example, the generator 118 is a true random number generator using a physical random source based, for example, on the intrinsic properties of a material on which it is implanted.

The processing device 102 further comprises a debug access circuit 116 (DEBUG INTERFACE) connected to the bus 120. For example, the circuit 116 is part of, or connected to, a Joint Test Action Group (JTAG) debug port or Serial Wire Debug Port (SW-DP) or other type of debug access circuit for the device 102. The circuit 116 allows a user to connect a compatible interface (not represented) to the device 102 in order to request execution of a system debugging procedure, for example in the event of malfunctions. According to the embodiments described herein, the circuit 116 is further configured to limit access to the debugging procedure based on the count value generated by the monotonic counter 106. For example, the monotonic counter 106 is controlled to increment its count value during operation of the device 102, for example during the boot phase of the device 102. Thus, it is possible to limit time periods during which the debugging operations are accessible.

The non-volatile memory 104 comprises, for example, an access control circuit 108 (ACCESS CONTROL) connected to the output of the monotonic counter 106. The memory 104 stores, for example, a plurality of data sets, for example boot codes and/or encryption keys, which are associated with a plurality of isolation levels, TIL (temporal isolation level). In the example of FIG. 1, the non-volatile memory 104 comprises a first area 122 in which a first set of data (ZONE0) is stored. The memory 104 further includes a second area 124, in which a second set of data (ZONE1) is stored, as well as a third area 126 in which a third set of data (ZONE2) is stored. The first, second and third data sets are, for example, associated with three corresponding TIL isolation levels. Although the case of three data sets is illustrated in FIG. 1, in other embodiments, the non-volatile memory 104 may store only two sets, or more than three sets of data, in corresponding areas.

The TIL level of isolation depends on the count value generated by the monotonic counter 106. In the example of FIG. 1, the TIL value is equal to the count value of the monotonic counter 106, although it would be possible to modify the count value to generate the TIL value.

The access control mechanism implemented by the circuit 108 can be implemented in several ways. In a first example, when the circuit 108 receives a read request, either by the device 102 itself or through the debug access circuit 116, associated with one or more addresses in the memory 104, it is configured to compare that/those address(es) to the address ranges associated with the areas 122, 124, and 126 of the memory 104. If it is an address in an area associated with a TIL value lower than the current value, the access control circuit 108 is for example configured to block the read operation. In a second example, the circuit 108 is configured to disable a read circuit of any area 122, 124, and 126 of the memory 104 associated with a TIL value lower than the current value. For example, one or more logic gates, such as OR gates or AND gates, are coupled into the output path of each area 122, 124, and 126 of the memory 104 and also receive a generated activation signal based on the TIL value to selectively disable each output path.

The fact that the TIL value cannot be decremented during the period of operation of the device 100 allows for the protection of the data sets, with the access control circuit 108 preventing them from being read based on a TIL value greater than the value associated with them.

In some embodiments, one or more of the data sets and associated isolation levels are reserved for separate entities in the chain from manufacturer to end user. For example, an intermediate entity between the manufacturer of the processing device and the end user of the electronic device 100 may be required to store data, such as boot codes, that are specific to the use of the device 100. In this case, one or more of the “lowest” data sets, such as those associated with the isolation level 0, are reserved for the manufacturer of the processing device 102, for example, and other sets are reserved for the intermediate entity.

However, when the device 102 presents one or more malfunctions, the manufacturer, the intermediate entity, or another entity, external to the manufacturer as well as the intermediate entity, may perform a debugging procedure. It is then desirable that the data sets associated with the TIL values reserved for the manufacturer and/or the intermediate entity are not accessible during this procedure.

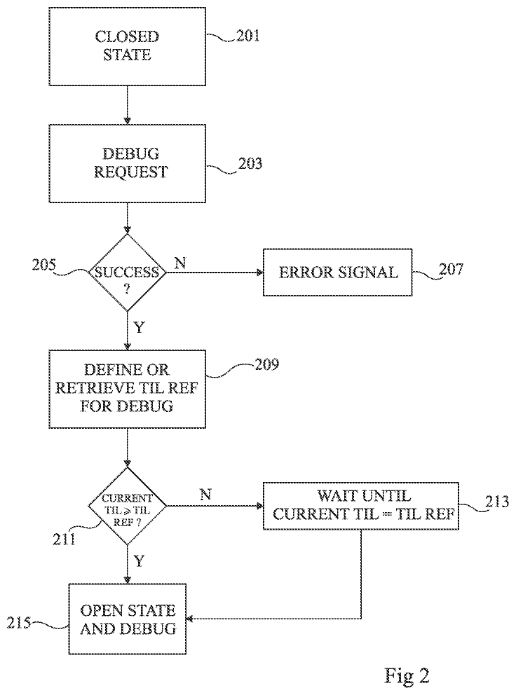

FIG. 2 is a flowchart representing operations of a method for opening the processing device 102 in debug mode according to an embodiment. This method is implemented, for example, by the debug access circuit 116 and the access control circuit 108 of the device 102.

In a step 201 (CLOSED STATE), the processing device has just been booted, and automatically goes into a so-called closed (or secure) state. In the closed state, access to debugging procedures is not permitted. The contents of the memories of the device 102, and in particular the contents of the areas 122, 124, and 126 of the non-volatile memory 104, are therefore rendered inaccessible from the outside by the debug access circuit 116. In other words, the execution of tests of the processing device 102 as well as a debugging protocol is not possible when the processing device 102 is in the closed state and this is true regardless of the current TIL value.

In a step 203 (DEBUG REQUEST), subsequent to step 201, an external debugging device is connected to the debug access circuit 116 to activate a debug mode of the device 102. For example, the external device sends a debug mode access request to the debug access circuit 116. Step 203 also comprises, for example, an authentication procedure initiated by the processing device 102. For example, this authentication procedure is based on the debug access circuit 116 verifying a digital signature generated by the external device, and provided with, or separately from, the debug mode access request.

In a step 205 (SUCCESS?), subsequent to step 203, the authentication procedure ends. Either the authentication procedure succeeds (Y branch) or it fails (N branch). In the case where the procedure fails, the method ends with a step 207 (ERROR SIGNAL) in which the processing device alerts the initiator of the authentication procedure that it has failed. For example this alert is an error message, or a beep.

In the event that the authentication procedure is successful, the method continues, in some cases, to a step 209 (DEFINE OR RETRIEVE TIL REF FOR DEBUG) in which one or more reference TIL values are, for example, defined or retrieved. The reference values indicate TIL values that are compatible with the debug mode access. For example, one or more reference values may define one or more TIL values for which the debug mode access is prevented, or one or more TIL values for which the debug mode access is permitted. In some cases, the reference TIL value is a threshold at or above which the debug mode access is permitted. In the following, the case in which a single reference TIL value indicating the threshold of the TIL value above which access to the debug mode is permitted is considered.

In some cases, the one or more reference TIL values are invariant and are stored in a memory of the device 102. In another example, the one or more reference TIL values may be set by a request from the external device.

In a step 211 (CURRENT TIL≥TIL REF?), subsequent to step 209, the current TIL value, corresponding to, for example, the count value of the monotonic counter, is compared to one or more reference TIL values, which were, for example, defined or retrieved in step 209. If the current TIL value is not greater than or equal to the reference TIL value (N branch), in other words, if the current TIL value is strictly less than the reference TIL value, the method is on hold for a step 213 (WAIT UNTIL CURRENT TIL=TIL REF) waiting for the monotonic counter 106 to be incremented and for the current TIL value to equal the reference TIL value. For example, in a boot of the processing device 102 in which the areas 122, 124, and 126 contain boot codes and in which the monotonic counter is incremented after the codes in each area are executed, the step 213 includes waiting, for example, for at least some steps in the boot method to complete.

Following the step 213, or if in the step 211 the current TIL value is at least equal to the reference TIL value (Y branch), the method terminates in a step 215 (OPEN STATE AND DEBUG) in which the circuit transitions from the closed state to an open state, allowing for the execution of tests and debugging protocols of the processing device 102 and the debugging procedure executes.

As an example in relation to FIG. 1, the processing device boots and, for example, the initial TIL value is 0. A request to enter the debug mode is transmitted to the debug access circuit 116 and the authentication of step 205 is successful. For example, following the step 209, the reference TIL value is identified as 3. For example, areas 122, 124, and 126 are associated with TIL values 0, 1, and 2, respectively, and contain boot codes. The debugging procedure is then pending in step 213 and the codes contained in area 122 are executed, causing the monotonic counter 106 to be incremented, and the TIL value is therefore equal to 1. The debugging procedure is still pending. The codes contained in area 124 are executed, causing the monotonic counter 106 to increment, so the TIL value is equal to 2. The debugging procedure is still pending. The codes contained in area 126 are executed, causing the monotonic counter 106 to increment, and the TIL value is therefore equal to 3. With the current TIL value equal to the reference TIL value, the debugging procedure can begin.

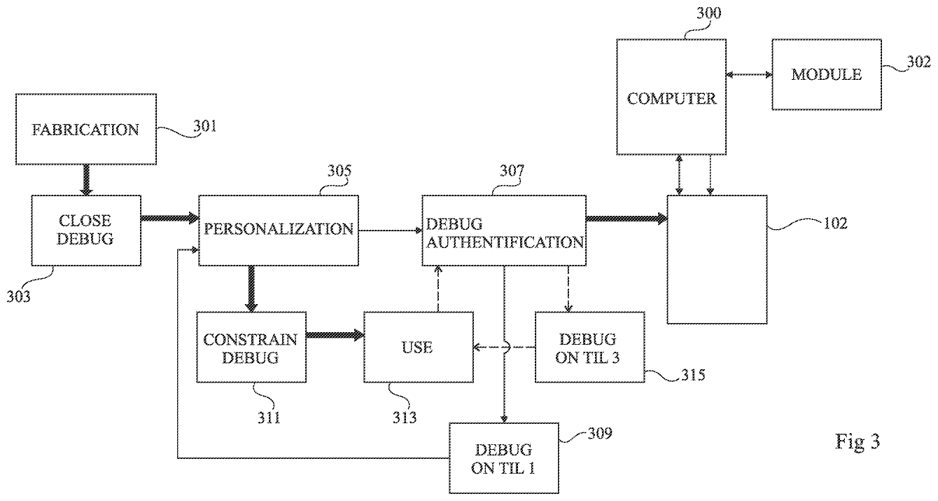

FIG. 3 illustrates an example of the life of the processing device allowing the implementation of a debugging procedure. Blocks referenced with odd numbers correspond to steps in the life of the processing device 102 according to an embodiment, and blocks referenced with even numbers correspond to hardware elements used to initiate and perform the debugging procedure.

The life of the processing device 102 begins in a fabrication step 301 (FABRICATION). During step 301, manufacturer-specific data, such as boot codes and encryption keys, are stored in the non-volatile memory 104 of the device 102. This data is confidential and the manufacturer of the device 102 does not want this data to be accessible by a third party. In the example of FIG. 3, the confidential data stored by the manufacturer is associated with the level value TIL 0. As an example in relation to FIG. 1, this data is stored in area 122 of the non-volatile memory 104.

The level value TIL 0 corresponds, for example, to the initial count value generated by the monotonic counter 106 when the device 102 is first booted.

Following storage of the confidential data and in a step 303 (CLOSE DEBUG), the debug access is closed. This implies that the debugging access is preceded by an authentication procedure for debugging.

For example, the device 102 is customized in a step 305 (PERSONALIZATION). For example, at this stage in the life of the device 102, the device 102 is in the hands of an intermediate entity. The intermediate entity is, for example, a reseller that will customize the device 102 to fit the operation of the electronic device 100. The intermediate entity will, for example, store other data, for example, other boot codes and other encryption keys, in another portion of the memory 104. In an example relative to FIG. 1, such other data is stored in areas 124 and 126. For example, a portion of the data stored by the intermediate entity is associated with the level value TIL 1 and is stored in area 124 and another portion of the data is associated with the level value TIL 2 and is stored in area 126.

In one example, following the step 305, the intermediate entity initiates a debugging procedure in a step 307 (DEBUG AUTHENTIFICATION). This procedure is initiated, for example, to verify proper operation of the device 102 following the customization.

For example, since the level value TIL 0 was closed in step 305, the reference value for this procedure is equal to 1. The flow of the debugging procedure when the reference value is equal to 1 is represented by the continuous thin arrow sequence. Once authentication for debugging is successful and the device 102 is opened for debugging, the device 102 is debugged in a step 309 (DEBUG ON TIL 1). In this step, the data associated with the level value TIL 0 is inaccessible in contrast to the data stored by, for example, the intermediate entity and associated with the level values TIL 1 and TIL 2. Once debugged, customization of the device 102 in step 305 may continue.

Following customization of the device 102 and in a step 311 (CONSTRAIN DEBUG), the reference TIL value is programmed to allow access to the debug mode only for TIL values greater than a reference value, for example the value 2 or 3. The memory areas associated with TIL values below the reference value are therefore locked, particularly with respect to debugging procedures. In particular, following the step 311, debugging of the “root of trust” type, associated for example with the level TIL 0 and/or 1, are no longer allowed.

Following the step 311, the device 102 is for example acquired and used in a step 313 (USE) by its end user.

During use, by the end user, the device 102 may be required to undergo a debugging procedure again, initiated by, for example, the manufacturer or another entity. In this case, the debugging procedure in step 307 (DEBUG AUTHENTIFICATION) is initiated. The flow of this debugging procedure is represented by the dotted arrow sequence.

Once authentication for debugging is successful and the device 102 is opened for debugging, the device 102 is debugged in a step 315 (DEBUG ON TIL 3). For example, because debugging is performed after step 311, in which debug access for a TIL value of 1 or less was locked, the reference TIL value identified by the device is greater than 1. In the example of FIG. 3, it is equal to 3.

In the debugging authentication step 307, a computing device 300 (COMPUTER) is, for example, connected to the device 102 via the debugging access circuit 116. The debugging authentication procedure is, for example, implemented by a digital signature protocol based on asymmetric cryptography. For example, the initiator of the debugging procedure has a card 302 (MODULE) containing a private key and connected to the computing device 300. For example, the random number generator 118 of the device 102 in FIG. 1 further transmits a random value to the computing device 300, via the debugging access circuit 116. The private key is used to sign the random value and the signed random value is transmitted to the cryptographic processor 114 of the device 102. The device 102 contains, for example, a public key. The public key is, for example, stored in the non-volatile memory 104 outside of areas 122, 124, and 126, or in other non-volatile memory not illustrated. The authenticity of the random value signature is then verified based on the public key. In one example, the private key used to enable debug mode access for the TIL value in step 309 is not the same as the private key used to enable debug mode access for the TIL value in step 315.

This authentication protocol is a non-limiting example. Other authentication protocols may be implemented.

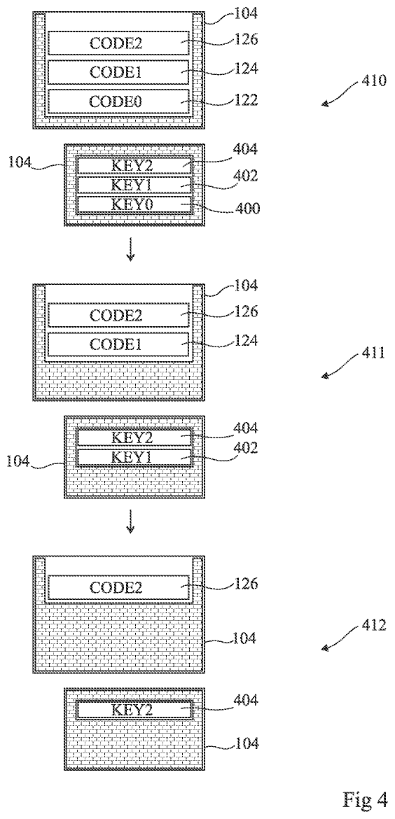

The FIGS. 4-6 illustrate embodiments in which the encrypted data are boot codes and/or encryption keys associated with those codes, and the TIL value is incremented at the end of each step in the boot sequence. Each TIL value further corresponds to one or more boot codes associated with each boot step; these codes are rendered inaccessible when the current TIL value is greater than their associated TIL value.

In the example of FIG. 4, memory areas 400, 402, and 404 store sensitive data associated with boot codes 122, 124, and 126, respectively, stored in the non-volatile memory 104. The areas 400, 402, and 404 are, for example, separate areas from the areas 122, 124, and 126, but remain associated with an isolation level corresponding to that of the boot codes to which the data is associated. This sensitive data includes, for example, one or more encryption keys stored in each area 400, 402, and 404, and each of these areas is contained in the non-volatile memory 104. According to another embodiment, each area 400, 402 and 404 is a sub-area of the corresponding area 122, 124 and 126.

During a first boot step 410, the processing device illustrated at the top of FIG. 4, the current count value is, for example, equal to 0. In the example of FIG. 4, an isolation level 0 is associated with a first code (CODE0) as well as first sensitive data (KEY0). The memory access control circuit 108 is configured, for example, so that this first code and these first data are exclusively accessible when the current count value is equal to 0. However, during the step 410, the access control circuit 108 authorizes, for example, access to all memory areas 122, 124 and 126, as well as to all areas 400, 402 and 404. Indeed, in some cases, in order to, for example, anticipate subsequent steps in the boot process, one or more other boot codes (CODE1, CODE2) are accessible for reading during the step 410.

For example, once the first code CODE0 is executed, the generic processor 110 controls a first increment of the current count value by the monotonic counter 106. For example, the first code comprises an instruction requesting the increment of the counter. This instruction is, for example, transmitted to a control register (not illustrated) of the monotonic counter 106.

After this first increment, the current count value of the monotonic counter 106 is, for example, equal to 1, corresponding to a second boot step 411. The access control circuit 108 receives the new current count value, and is configured to prevent, based on this count value greater than 0, any access to the first code as well as to the first data that is associated with isolation level 0. In other words, the memory areas 122 and 400 are locked based on any count value strictly greater than 0.

The isolation level 1 is associated with a second code (CODE1) contained in the area 124 as well as with the second data (KEY1) contained in the area 402. According to one embodiment, a third code (CODE2), for example associated with the isolation level 2 and contained in the area 126, is accessible for reading based on the current count value being equal to 1.

For example, once the second code CODE1 is executed, the generic processor no controls a second increment of the current count value by the monotonic counter 106. For example, after this second increment, the current count value of the monotonic counter 106 is equal to 2, corresponding to a third boot step 412. The isolation level 2 is associated with the third code CODE2 as well as the third data (KEY2). The access control circuit 108 receives the new count value, and is configured to prevent, based on this count value greater than 1, any access to the first and second codes as well as the first and second data that are associated with the isolation levels less than or equal to 1.

According to one embodiment, when the last boot code is executed, for example the third boot code, the generic processor no controls a third increment of the current count value by the monotonic counter. The access control circuit 108 then locks out all access to the first, second, and third boot codes and the first, second, and third data.

According to another embodiment, when the last boot code is executed, for example the third boot code, the current count value is not incremented by the monotonic counter 106 and access to the third boot code as well as the third data remains allowed by the access control circuit 108.

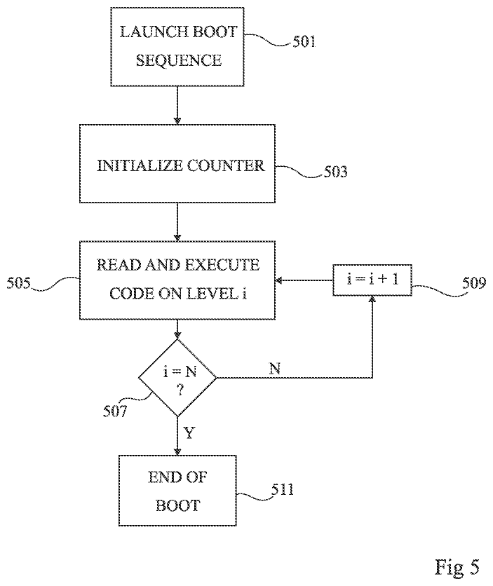

FIG. 5 is a flowchart representing operations of a secure boot method of a processing device according to an embodiment. This method is implemented, for example, by the generic processor no, the monotonic counter 106, and the access control circuit 108 of the processing device of FIG. 1.

In a step 501 (LAUNCH BOOT SEQUENCE) the processing device 102 is booted. In one example, this is the first boot of the device 102 after its manufacture. In another example, it is a boot performed by an intermediate entity between the manufacturer of the device 102 and its end user. In yet another example, it is a so-called operational boot of the electronic device 100 performed by the end user.

In a step 503 (INITIALIZE COUNTER), subsequent to step 501, the monotonic counter is initialized to an initial value, being a natural number. In the example in which the count value is stored in a volatile manner, each boot of the processing device causes the count value to be initialized, for example to 0 or 1. In another example in which the count value is stored in a non-volatile storage element, each boot of the processing device causes the current count value to be replaced with the initial count value, for example equal to 0 or 1.

In some embodiments, the initial count value generated following a boot, may vary depending on the state, or context, of the processing device 102. For example, one or more count values corresponding to one or more isolation levels reserved for an initial set-up phase of the device 102, comprising, for example, the installation of firmware. The data and/or codes associated with these isolation levels are, for example, used for this initial set-up.

For example, following manufacture, the processing device 102 has the context “blank” and the initial count value is equal to a value reserved for setting-up, such as 0. Once the set-up is complete, the context of the device becomes, for example, “set-up complete.” With this new context, booting the device 102, for example by an intermediate entity between the manufacturer and the end user and/or by the end user, will then trigger a count value greater than the reserved count value, and for example equal to 1. The boot code(s), as well as the sensitive data, associated with the isolation level corresponding to the reserved count value will, therefore, be inaccessible.

For example, the context of the device is detected by the presence of a voltage on a start-up pin of the device, this voltage being applied, for example, by adding a jumper between the start-up pin and another pin at a supply voltage. Additionally or alternatively, the context of the device is detected by the value of one or more bits stored in a non-volatile, protected manner in the memory 104, or in another memory.

In one example, the generic processor no is arranged to detect the context of the device 102 upon booting the device 102, and to configure the initial count value of the monotonic counter 106 accordingly. In another example, the monotonic counter 106 is arranged to detect the context of the device 102 itself and to configure its initial count value itself, upon booting the device 102.

In a step 505 (READ AND EXECUTE CODE ON LEVEL i), subsequent to step 503, the data and boot codes associated with the isolation level i are read by the generic processor 110 and the boot codes associated with the isolation level i are executed. Once the codes of level i are executed, the generic processor no compares, in a step 507 (i=N?) the count value i to the value N, where N is the count value associated with the last step in the boot sequence, in other words, the boot codes of isolation level N are the last to be executed according to an embodiment. For example, in the example of FIG. 4, N is equal to 2. If i is not equal to N (N branch), the method continues in a step 509 (i=i+1) in which the generic processor triggers the increment of the count value. For example, the count value increases from i to i+1. It is also possible that the increment increases the value i by several units. The method then resumes at step 505.

In the event that, as a result of the comparison step 507, the count value is equal to N (Y branch), the method concludes with a step 511 (END OF BOOT) in which the boot of the processing device ends. According to one embodiment, the current count value remains equal to N following the step 511. According to another embodiment, the count value is incremented in the step 511, and the current count value becomes equal to N+1. In this second embodiment, the access control circuit 108 is configured to prevent access to all boot codes based on this count value.

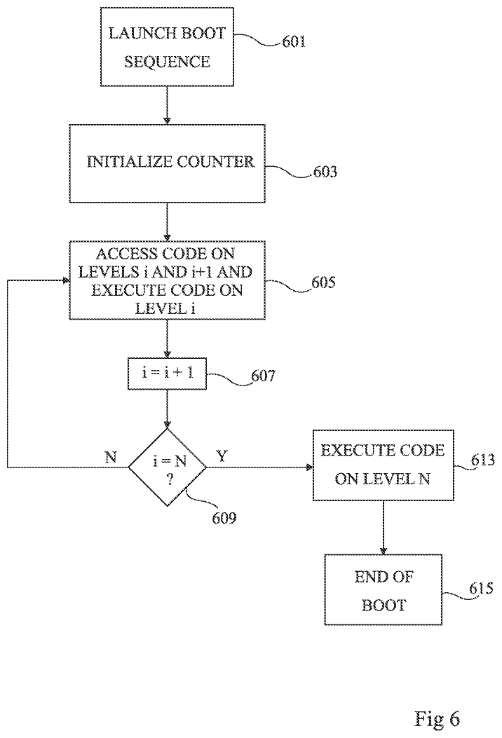

FIG. 6 is a flowchart representing operations of a secure boot method of a processing device according to another embodiment. This method is implemented, for example, by the generic processor no, the monotonic counter 106, and the access control circuit 108 of the processing device of FIG. 1.

Steps 601 and 603 are similar to steps 501 and 503 of FIG. 5 and will not be described again in detail.

In a step 605 (ACCESS CODE ON LEVELS i AND i+1 EXECUTE CODE ON LEVEL i), subsequent to step 603, the data and boot codes associated with the isolation levels i+1 are accessed by the generic processor no and the boot code(s) associated with the isolation level i are executed.

In one example, the data or codes associated with the isolation level i contain one or more encryption keys, encrypted or unencrypted, which will be used when executing one or more codes associated with isolation level i+1. Thus, a write access is for example authorized on the memory area(s) associated with the isolation level i+1 in order to provision the keys to the codes associated with the isolation level i+1.

In another example, the codes associated with isolation level i contain instructions to verify the integrity of the data and/or codes associated with isolation level i+1. Thus, read access to the memory area(s) associated with isolation level i+1 is permitted in order to perform this verification.

In a step 607 (i=i+1), subsequent to step 605, the count value is incremented. For example, the count value increases from i to i+1. In other examples, the increment increases i by several units.

In a step 609 (i=N?) the generic processor no compares the count value i to the value N, where N is defined as described, relative to step 507 of FIG. 5. If the value i is not equal to N (N branch) the method returns to step 605.

In the event that in the comparison step 609 the count value is equal to N (Y branch), the method continues to a step 613 (EXECUTE CODE ON LEVEL N) in which the boot code(s) associated with the isolation level N are executed.

The boot of the processing device ends with a step 615 (END OF BOOT), which is similar to the step 511 of FIG. 5 and is not described again in detail.

The method whose implementation is shown in FIG. 6 allows for a staggered reading of the boot codes. Indeed, the boot codes associated with an isolation level are read when the count value is lower than the level value. This saves time compared to the implementation of the method presented in FIG. 5.

One advantage of the described embodiments is that sensitive data in terms of confidentiality, are protected in a significant way by the use of a monotonic counter and in particular to the lock access during a debugging procedure.

Another advantage of the described embodiments is that they are easily adaptable to several boot architectures.

Various embodiments and variants have been described. Those skilled in the art will understand that certain features of these embodiments can be combined and other variants will readily occur to those skilled in the art. In particular, different types of processors may be used. In addition, the number of isolation levels may vary.

Finally, the practical implementation of the embodiments and variants described herein is within the capabilities of those skilled in the art based on the functional description provided hereinabove. In particular, authentication protocols for debugging other than an asymmetric cryptography protocol can be implemented.

What is claimed is:

1. A method for debugging a processing device, the method comprising:
generating, by a monotonic counter of the processing device, a first count value;
transmitting, by the monotonic counter, the first count value to a debug access control circuit;
comparing, by the debug access control circuit of the processing device, the first count value with one or more reference values; and
authorizing or preventing debug access, by the debug access control circuit, based on the comparison.

2. The method according to claim 1, wherein the first count value is generated in a first step of a boot sequence of the processing device, and wherein the first step comprises incrementing the monotonic counter to a second count value after transmitting the first count value.

3. The method according to claim 2,
wherein the authorizing or preventing comprises preventing the debug access based on the first count value,
wherein the method further comprises:
transmitting, by the monotonic counter, the second count value to the debug access control circuit;
comparing, by the debug access control circuit, the second count value with the one or more reference values; and
authorizing the debug access based on the second count value.

4. The method according to claim 2,
wherein the first count value corresponds to an initialization value of the monotonic counter for a first boot of the processing device, and
wherein the second count value corresponds to an initialization value of the monotonic counter for a second boot of the processing device.

5. The method according to claim 4,
wherein, during the first boot, the processing device is initially placed in a first state,
wherein the debug access, by the debug access circuit, is authorized based on the first count value, and
wherein, during the second boot, the processing device is locked in a second state, and
wherein the debug access, by the debug access circuit, is prevented based on the first count value.

6. The method according to claim 2, further comprising:
transmitting the first count value, by the monotonic counter, to the access control circuit of a memory of the processing device;
reading, based on the first count value, first data stored in the memory;
transmitting the second count value, by the monotonic counter, to the access control circuit; and
reading, based on the second count value, second data stored in the memory,
wherein reading, by the access control circuit, the first data is not authorized based on the second count value.

7. The method according to claim 6,
wherein, during the first boot, the processing device is initially placed in a first state,
wherein the debug access, by the debug access circuit is authorized based on the first count value,
wherein, during the second boot, the processing device is locked in a second state,
wherein the debug access, by the debug access circuit, is prevented based on the first count value, and
wherein the first and second states of the processing device are defined by one or more values stored in the memory.

8. The method according to claim 1, wherein the debug access control circuit authorizes the debug access based on a count value greater than or equal to the one or more reference values and prevents the debug access based on a count value strictly less than the one or more reference values.

9. The method according to claim 1, further comprising, prior to authorizing or preventing the debug access:
receiving, by the debug access circuit, a debug access request from an external device; and
verifying, by the debug access circuit, authentication of the external device,
wherein authorizing or preventing the debug access, by the debug access control circuit, is also performed based on verifying the authentication.

10. A data processing device comprising:
a monotonic counter configured to generate a first count value; and
a debug access control circuit configured to:
compare the first count value with one or more reference values; and
authorize or prevent debug access based on the comparison.

11. The data processing device according to claim 10, wherein the monotonic counter is configured to:
generate the first count value in a first step of a boot sequence of the data processing device, and
generate a second count value after transmitting the first count value, the first step including incrementing the monotonic counter to the second count value.

12. The data processing device according to claim 11,
wherein the monotonic counter is configured to transmit the second count value to the debug access control circuit when the debug access, based on the first count value, is prevented, and
wherein the debug access control circuit is configured to:
compare the second count value with the one or more reference values; and
authorizing the debug access based on the second count value.

13. The data processing device according to claim 11,
wherein the first count value corresponds to an initialization value of the monotonic counter for a first boot of the processing device, and
wherein the second count value corresponds to an initialization value of the monotonic counter for a second boot of the processing device.

14. The data processing device according to claim 11, further comprising:
a memory comprising the access control circuit,
wherein the monotonic counter is configured to:
transmit the first count value to the access control circuit, and
transmit the second count value to the access control circuit after the first count value is transmitted,
wherein the access control circuit is configured to:
read, based on the first count value, first data stored in the memory, and
read, based on the second count value, second data stored in the memory, and
wherein reading the first data is not authorized based on the second count value.

15. The data processing device according to claim 14, wherein the memory is a non-volatile memory.

16. The data processing device according to claim 10, wherein the debug access control circuit is configured to:
authorize the debug access based on a count value greater than or equal to the one or more reference values, and
prevent the debug access based on a count value strictly less than the one or more reference values.

17. The data processing device according to claim 10, wherein the debug access circuit is configured to:
receive a debug access request from an external device prior to authorizing or preventing the debug access;
verify authentication of the external device; and
based on the verification of the authentication, authorize or prevent the debug access.
